(19) United States
(12) Patent Application Publication
(10) Pub. No.: US 2017/0141465 A1
(43) Pub. Date: May 18, 2017

(54) INTEGRATED MICROWAVE-MILLIMETER WAVE ANTENNA SYSTEM WITH ISOLATION ENHANCEMENT MECHANISM

(71) Applicant: KING FAHD UNIVERSITY OF PETROLEUM AND MINERALS, DHAHRAN (SA)

(72) Inventor: MOHAMMAD S. SHARAWI, DHAHRAN (SA)

(21) Appl. No.: 14/940,105

(22) Filed: Nov. 12, 2015

(51) Int. Cl. H01Q 5/20; H01Q 1/48; H01Q 21/30; H01Q 5/50; H01Q 9/04; H01Q 13/10; H01Q 1/12; H01Q 1/50

(52) U.S. Cl. CPC H01Q 5/20; H01Q 1/12; H01Q 1/48; H01Q 1/50; H01Q 5/50; H01Q 9/04; H01Q 13/10; H01Q 21/30

(57) ABSTRACT

The integrated microwave-millimeter wave antenna system with isolation enhancement mechanism is a planar, compact, multi-band microwave multiple-input-multiple-output (MIMO) antenna system integrated with a millimeter wave antenna array. The microwave MIMO antenna system covers multiple standards between (700-6000) MHz, while the millimeter wave array covers a wider bandwidth of at least 1 GHz with a center frequency ranging from 28-38 GHz. The millimeter wave antenna array is based on slot antenna elements and acts as an isolation enhancement structure to the microwave MIMO antenna system. It acts as a defected ground structure that improves port isolation of the MIMO antenna system. This dual functionality within a small form factor wireless device is highly desirable, as space is very limited. The system is for beyond 4G wireless standards.

### BACKGROUND OF THE INVENTION

1. Field of the Invention

The present invention relates to multi-band antennas, and particularly to an integrated microwave-millimeter wave antenna system with isolation enhancement mechanism that provides multiple-input-multiple-output (MIMO) microwave antennas combined with millimeter wave integrated antenna arrays for compact wireless devices and 4G+ and 5G mobile handsets and sub-systems.

2. Description of the Related Art

The use of wireless terminals is on the rise worldwide, from cell phones and, tablet PCs to iPADs and personal digital assistants (PDAs), among many other devices that have wireless connectivity capability. This tremendous proliferation of wireless devices with Internet connectivity has posed several demands on higher data throughput to allow users to experience multimedia and video streaming. In the fourth generation (4G) mobile terminals, multiple-input-multiple-output (MIMO) technology was a major enabling technology for such increase in data throughput through the use of multiple antenna elements on the mobile device, as well as at the base-station. The demand for higher data rates will keep increasing, and the fifth generation (5G) of wireless standards will try to provide a 1000 times increase of data throughput compared to the current 4G standard speeds through the utilization of several new enabling technologies.

Although MIMO antenna systems will be key in 5G standards, as they should be backward compatible with previous ones that can cover wide ranges, short-range communication standards are recently investigating millimeter-wave (mm-wave) bands (30 to 300 GHz, or wavelengths from ten to one millimeter) for ultra-high throughput over short distances to allow for real-time multimedia and video transfers, and to achieve the anticipated increase in the data rates. Such bands include, but are not limited to, 28 GHz and 38 GHz, as recently demonstrated. The integration of MIMO technology at microwave frequencies covering the current 4G standards, along with mm-wave bands, will be required in next generation wireless devices, as they are supposed to support both standards. The mm-wave antenna should be able to provide at least 1 GHz of bandwidth, while the microwave MIMO antenna system can still support the regular wireless bands. This integration process needs careful attention and is of primary importance to wireless device manufacturers.

Thus, an integrated microwave-millimeter wave antenna system with isolation enhancement mechanism solving the aforementioned problems is desired.

### SUMMARY OF THE INVENTION

The integrated microwave-millimeter wave antenna system with isolation enhancement mechanism is a planar, compact, multi-band microwave multiple-input-multiple-output (MIMO) antenna system integrated with a millimeter wave antenna array. The microwave MIMO antenna system covers multiple standards between 700-6000 MHz, while the millimeter wave array covers a wider bandwidth of at least 1 GHz with a center frequency ranging from 28-38 GHz. The millimeter wave antenna array is based on slot antenna elements and acts as an isolation enhancement structure to the microwave MIMO antenna system. The array acts as a defected ground structure that improves port isolation of the MIMO antenna system. This dual functionality within a small form factor wireless device is highly desirable, as space is very limited. The system is for beyond 4G wireless standards.

These and other features of the present invention will become readily apparent upon further review of the following specification and drawings.

### BRIEF DESCRIPTION OF THE DRAWINGS

FIG. 1A is a plan view showing the top surface or layer of the antenna board of an integrated microwave-millimeter wave antenna system with isolation enhancement mechanism according to the present invention, showing the MIMO antenna system for operation in the microwave band.

FIG. 1B is a plan view of the metallic middle layer of the antenna board of FIG. 1a, showing the ground plane and the millimeter wave antenna array etched in the ground plane.

FIG. 1C is a bottom view of the antenna board of FIG. 1A, showing the feed elements of the millimeter wave antenna array.

FIG. 2 is a schematic composite top plan view of the antenna board of FIGS. 1A-1C, showing the relative positioning of the antenna elements on the three layers of the antenna board.

FIG. 3A is a top view in section of an alternative configuration of a MIMO microwave antenna element for the top surface of the antenna board of FIG. 1A.

FIG. 3B is a top view in section of an alternative configuration of a MIMO microwave antenna element for the top surface of the antenna board of FIG. 1A.

FIG. 4A is a detailed schematic diagram of the feed elements of the millimeter wave antenna array shown in FIG. 1C.

FIG. 4B is a detailed schematic diagram of an alternative configuration of the feed elements of the millimeter wave antenna array shown in FIG. 1C.

FIG. 5A is a schematic composite top plan view of the antenna board of an alternative embodiment of an integrated microwave-millimeter wave antenna system with isolation enhancement mechanism according to the present invention.

FIG. 5B is a schematic composite top plan view of the antenna board of another alternative embodiment of an integrated microwave-millimeter wave antenna system with isolation enhancement mechanism according to the present invention.

FIG. 6A is a schematic composite top plan view of the antenna board of another alternative embodiment of an integrated microwave-millimeter wave antenna system with isolation enhancement mechanism according to the present invention.

FIG. 6B is a schematic composite top plan view of the antenna board of another alternative embodiment of an integrated microwave-millimeter wave antenna system with isolation enhancement mechanism according to the present invention.

Similar reference characters denote corresponding features consistently throughout the attached drawings.

### DETAILED DESCRIPTION OF THE PREFERRED EMBODIMENTS

The integrated microwave-millimeter wave antenna system with isolation enhancement mechanism is a multi-band antenna structure covering several microwave wireless standard bands (this can be tuned according to the coverage area) with sufficient bandwidth. The millimeter wave antenna component includes a planar slot-based antenna array having a feeding structure, and provides operation centered at any frequency between 28-38 GHz with at least 1 GHz of operating bandwidth. The mm-wave array will act as a defected ground structure for the MIMO antenna system, and thus a novel isolation enhancement method, although multi-standard integration is also provided.

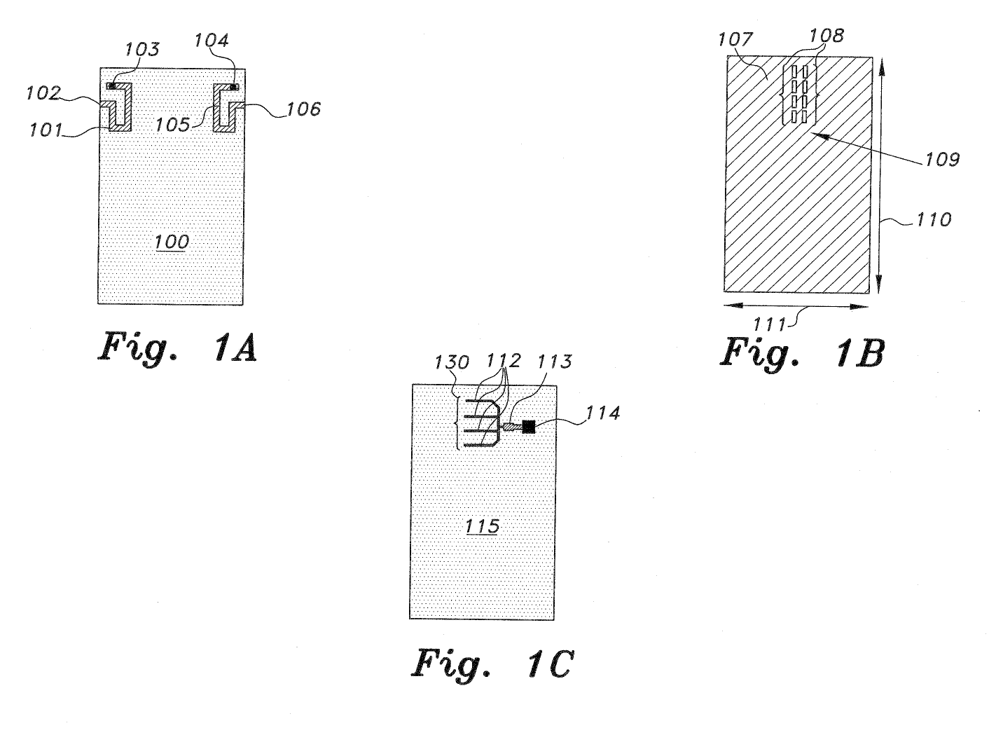

FIGS. 1A, 1B, and 1C show the three printed circuit board layers of the planar printed multi-band microwave and millimeter-wave integrated antenna system having a total width dimension 111 and length dimension 110. A top layer 100 of the antenna system's printed circuit board (PCB) has first and second G-shaped element multi-band MIMO antennas 101 and 105, respectively, providing operation at microwave frequencies. Antennas 101 and 105 are fed from the edge of the board at terminal feed points 102 and 106, respectively. Multi-band operation can be achieved using shorting strips or posts 103, 104 disposed opposite the end of the antennas where the terminal feed points 102 and 106 are located. A middle metallic layer 107 of the PCB is separated from the top layer 100 by a dielectric substrate and contains the ground plane of the system, as well as a group of slot openings 108 within the ground plane (GND) at a locus where metal of the layer is etched off to form the slots. The group of slots 108 forms a planar array 109.

The planar slot array 109 will act as an isolation enhancement structure for the MIMO antenna system at microwave frequencies, as well as a millimeter wave antenna array at millimeter wave frequencies. The bottom layer 115 contains the feed network of the millimeter wave slot antenna array 109 of the second substrate layer. The feed arms 112 form a power divider feed network 130 and are fed via an impedance transformer 113 in operable communication with a connector 114.

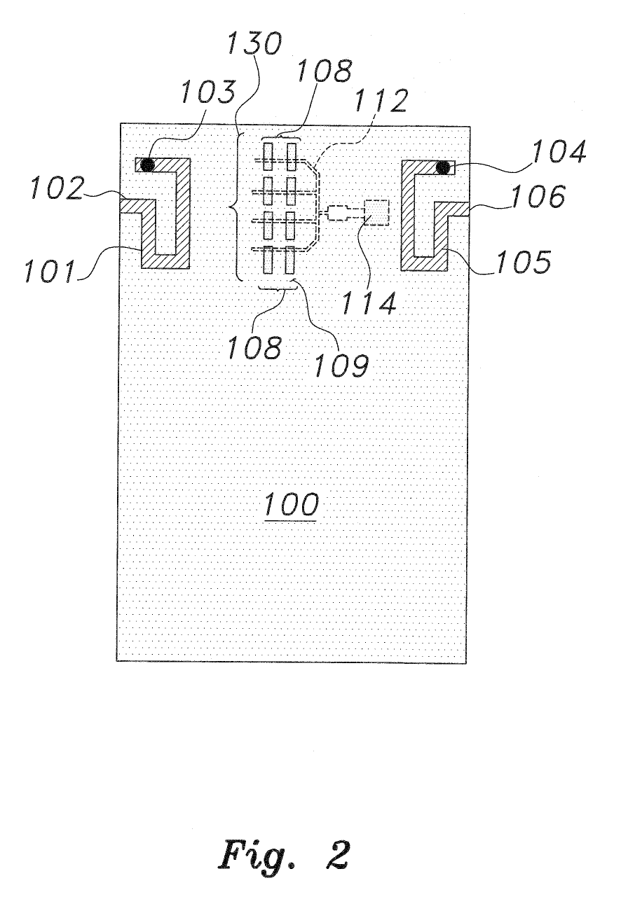

FIG. 2 shows a composite top view of the complete system, with the two MIMO antenna elements G shaped element multi-band MIMO antennas 101 and 105, their feed points 102, 106, and shorting strips/posts 103, 104 on the top layer. Also, the millimeter wave slot antenna array 109 is shown disposed in the middle layer ground plane, along with the feed arms 112 of the feed network 130 in the bottom layer, and the input feed connector 114 of the millimeter-wave array 109.

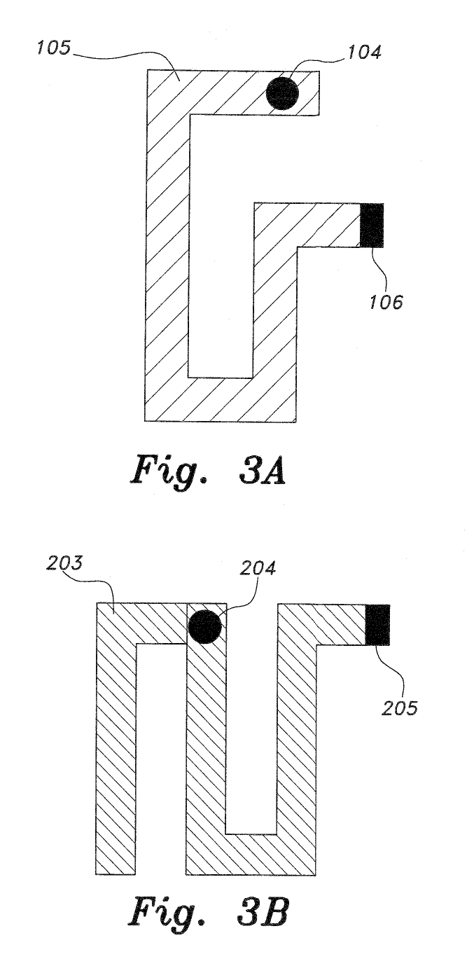

Alternative configurations of the antenna elements for the multi-band microwave MIMO antenna system are shown in FIGS. 3A and 3B. FIG. 3A is a detailed schematic view in section of the second G-shaped element 105 configured as a shorted loop antenna with a feed connector 106 at the terminus of the G-shaped element 105. Shorting strip/post 104 is disposed on the G-shaped element 105 proximate the end opposing the terminus end. The shorting post 104 selectively connects the G-shaped element with the ground plane in the middle layer when inserted through the board. An exemplary alternative antenna element (shown in FIG. 3B) is a shorted meander line 203. Other alternatives may be, without limitation, an inverted-F antenna, or any other derivative of the shorted meander line-based antenna 203. The feed point 205 is shown at a terminus of the meander line 203, and the shorting strip/port 204 is placed in an optimized location to provide dual band coverage with enough impedance bandwidth (shown at a fourth bend, away from the terminus of the meander line 203). The band covered can be varied according to the operator specific frequency bands. Possible covered bands would be the lower 800/900 MHz bands, as well as the upper 1800/2100 MHz bands, or even the WLAN band at 2.45 GHz.

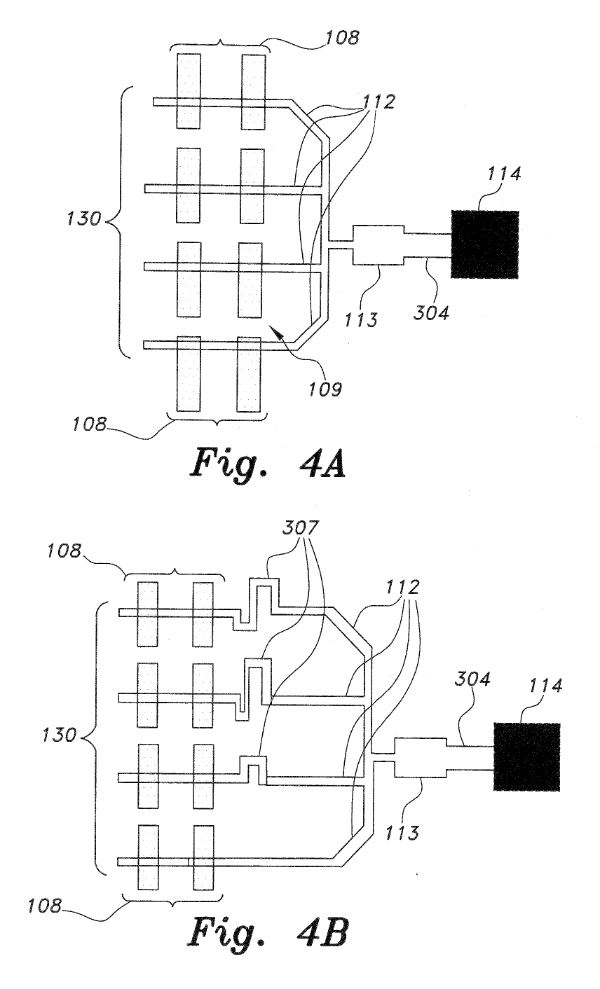

The millimeter wave antenna array 109 with feed arms 112 is shown schematically in FIG. 4A. The array 109 has two roles in this integrated design. The first is to act as an isolation enhancement structure for the MIMO antenna system working at microwave frequencies. The second is a stand-alone millimeter wave antenna array for short range communication standards, with a center frequency ranging between 28-38 GHz. A bandwidth of at least 1 GHz should be provided for ultra high-speed communication systems for short range links. Two variations are shown for such an array. The array 109 consists of a planar arrangement of slot antenna elements 108 etched out of the ground plane, a feed network/power divider 130, an impedance transformer 113, a feed line 304, and the input connector 114.

This antenna array 109 will provide a radiation pattern beam focused at the normal of the array plane from both of its sides. If a tilted beam pattern is required (for example, to lower field interactions with other radiating elements) a modified design can be considered, as shown in FIG. 4B, wherein some phase shifting (meandering) lines 307 are introduced in the feed arms 112 to provide a progressive phase variation to tilt the beam.

A possible response curve for such an array covers the 28 GHz band of the millimeter-wave spectrum, and with a bandwidth of at least 1 GHz dedicated for short range ultra high-speed data connections, and a three-dimensional radiation pattern.

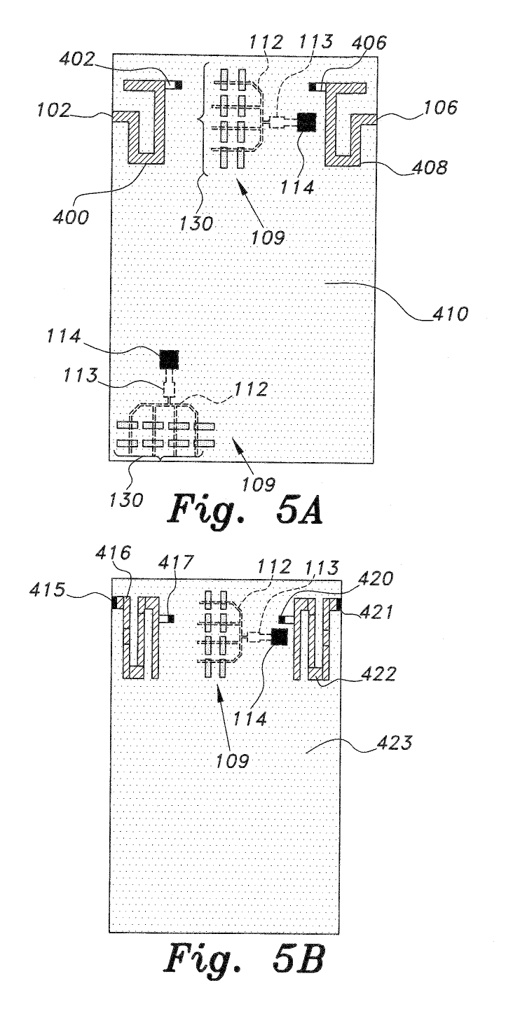

Other possible arrangements of the present multi-layered, integrated microwave MIMO and millimeter wave antenna system are shown in FIGS. 5A and 5B. The configuration 410 shown in FIG. 5A includes microwave multi-band dual element MIMO antenna elements 400, 408, utilizing a modified-G antenna shape, and the two feeds 102, 106. Included are shorting strips 402 and 406, which are disposed on respective extension ends of the head portion of the G-shaped elements 400 and 408. Moreover, a MIMO configuration 410 of the millimeter wave antenna system includes two instances of the array 109. The first instance of the array 109 is disposed in line between the G-elements 400 and 408. The second instance of the array 109 is disposed opposite G-element 400 in a configuration having an orientation rotated 90° from the first instance of the array 109. One of arrays 109 serves as an isolation enhancement structure for the microwave MIMO antenna system 410, while the other is a radiating element for the millimeter wave antenna. The configuration 423 shown in FIG. 5B is another possible dual-band microwave MIMO antenna system having meander line antenna elements 416 and 422 integrated with a millimeter wave array 109 aligned between elements 416 and 422. Included are shorting strips 417 and 420, which are disposed on respective lines extending from the fifth and sixth meander-lines, respectively, of the meander line elements 416 and 422. Shorting strip 417 of element 416 is offset from feed point 415. Shorting strip 420 of element 422 is axially aligned (along an axis running parallel to the PC board) with feed point 421. A single feed 114 is in operable communication with the millimeter wave array 109.

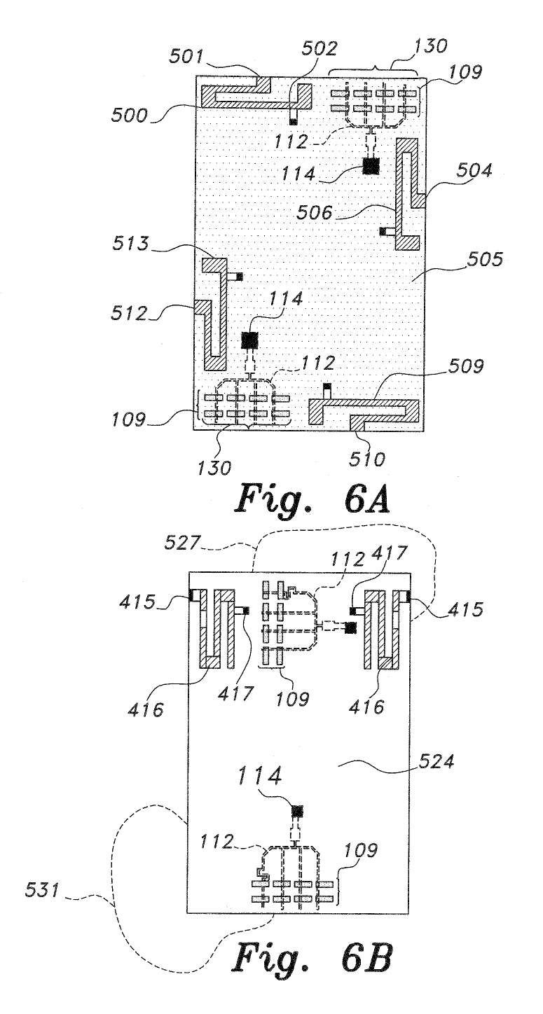

Other alternative designs based on the integrated structure are shown in FIGS. 6A and 6B. In FIG. 6A, the top view of configuration 505 of the multi-layered board design shows a four-element multi-band MIMO antenna system operating at microwave frequencies. Elements 500, 506, 509, and 513 are disposed on the four edges of the antenna PC board, with their respective input feed points 501, 504, 510, 512, and integrated with a pair of millimeter-wave antenna arrays 109. The configuration 505 with positioning of the antenna arrays 109 serves as a MIMO antenna system at millimeter wave, as well as two isolation enhancement structures at microwave frequencies, disposed between each pair of the lower band MIMO antenna elements (500 and 506, 513 and 509). This configuration will provide enhanced microwave MIMO links, as well as millimeter wave communication links through the millimeter wave-MIMO configuration. The isolation enhancement from the millimeter wave arrays will directly affect the performance of the microwave MIMO systems and enhance their port isolation and correlation coefficient, in addition to their efficiencies.

Another variation for the present multi-layered PCB integrated system is a dual-element MIMO antenna system at microwave as well as a dual antenna array MIMO system at millimeter waves, as shown in a schematic top view of the system 524 in FIG. 6B. The dual-element multi-band microwave MIMO antenna system 524 includes two instances of MIMO meander line antenna element 416 aligned in mirror image fashion on opposing sides of the PC board, along with two instances of millimeter wave antenna array system 109, the first instance of the array 109 being aligned between the mirror-imaged elements 416, the second instance of the array 109 being disposed at the opposite end of the board from the first instance and having an orientation rotated 90° from the first instance of array 109. The orientation of these arrays 109 are tilted with respect to one another to provide lower field correlations by making the two field maxima 527, 531 point in opposite directions.

It is to be understood that the present invention is not limited to the embodiments described above, but encompasses any and all embodiments within the scope of the following claims.

I claim:

1. An integrated microwave-millimeter wave antenna system with isolation enhancement mechanism, comprising:
a printed circuit board having a top surface layer, a bottom surface layer, a middle layer, and dielectric substrate disposed between the top layer and the middle layer, and between the middle layer and the bottom layer;
a first microwave MIMO antenna and a second microwave MIMO antenna disposed on the top layer of the printed circuit board;
a ground plane formed on the middle metallic layer;
a first plurality of slot openings within the ground plane defining a first millimeter wave planar array antenna; and
a first power dividing feed network disposed on the bottom layer, the first power dividing feed network feeding the first millimeter planar array antenna.

2. The integrated microwave-millimeter wave antenna system according to claim 1, further comprising:
an impedance transformer disposed on the bottom layer, the transformer being connected to the power dividing feed network; and
an impedance transformer connector disposed on the bottom layer in operable communication with the impedance transformer.

3. The integrated microwave-millimeter wave antenna system according to claim 2, wherein the power divider network further comprises progressively long meandering lines disposed in feeder arms of the power divider network.

4. The integrated microwave-millimeter wave antenna system according to claim 1, further comprising:
a first microwave MIMO antenna feeder connected to the first microwave MIMO antenna; and
a second microwave MIMO antenna feeder connected to the second microwave MIMO antenna.

5. The integrated microwave-millimeter wave antenna system according to claim 4, wherein the first microwave MIMO antenna feeder and the second microwave MIMO antenna feeder are disposed at opposite ends of the printed circuit board.

6. The integrated microwave-millimeter wave antenna system according to claim 4, wherein the first microwave MIMO antenna feeder and the second microwave MIMO antenna feeder are disposed adjacent orthogonal edges of the printed circuit board.

7. The integrated microwave-millimeter wave antenna system according to claim 4, further comprising:
a first shorting strip connected to the first microwave MIMO antenna; and
a second shorting strip connected to the second microwave MIMO antenna.

8. The integrated microwave-millimeter wave antenna system according to claim 7, wherein at least one of the microwave MIMO antennas is a shorted loop antenna.

9. The integrated microwave-millimeter wave antenna system according to claim 7, wherein at least one of the microwave MIMO antennas is a shorted meander line antenna.

10. The integrated microwave-millimeter wave antenna system according to claim 9, wherein the shorting strip and the antenna feeder of the shorted meander line antenna are axially aligned along an axis running parallel to the printed circuit board.

11. The integrated microwave-millimeter wave antenna system according to claim 1, wherein the first microwave MIMO antenna and the second microwave MIMO antenna are disposed in mirror image fashion on laterally opposing sides of the printed circuit board.

12. The integrated microwave-millimeter wave antenna system according to claim 1, wherein the first millimeter planar array antenna is disposed between the first and second microwave MIMO antennas.

13. The integrated microwave-millimeter wave antenna system according to claim 1, further comprising:
a second millimeter planar array antenna disposed on the middle layer, the first and second millimeter planar array antennas being disposed at opposite ends of the printed circuit board; and
a second power dividing feed network on the bottom layer feeding the second millimeter planar array antenna.

14. The integrated microwave-millimeter wave antenna system according to claim 13, wherein the second millimeter planar array antenna is disposed in a configuration having an orientation rotated 90° from the first millimeter planar array antenna.

15. The integrated microwave-millimeter wave antenna system according to claim 13, further comprising:
a third microwave MIMO antenna disposed on the top layer of the printed circuit board; and
a fourth microwave MIMO antenna disposed on the top layer of the printed circuit board.

16. The integrated microwave-millimeter wave antenna system according to claim 15, wherein the second millimeter planar array antenna is disposed between the third and fourth microwave MIMO antennas.
